(19) United States
(12) Patent Application Publication
(10) Pub. No.: US 2020/0194890 A1
(43) Pub. Date: Jun. 18, 2020

(54) ANTENNAS IN ELECTRONIC DEVICES

(71) Applicant: HEWLETT-PACKARD DEVELOPMENT COMPANY, L.P., Spring, TX (US)

(72) Inventors: Kuan-Jung Hung, Taipei (TW); Cheng Chih Chen, Taipei (TW)

(21) Appl. No.: 16/481,476

(22) PCT Filed: Oct. 18, 2017
(86) PCT No.: PCT/US2017/057184

§ 371 Date: Jul. 28, 2019

(30) Foreign Application Priority Data
Jan. 26, 2017 (US) 62450858

(51) Int. Cl. H01Q 5/314; H01Q 1/22

(52) U.S. Cl. CPC H01Q 5/314; H01Q 1/2291; H01Q 1/2266

(57) ABSTRACT

The present subject matter describes antennas in electronic devices. Sn an example implementation, an electronic device includes a first antenna coupled to a high band Wireless Wide Area Network (WWAN) main signal processor, where the first antenna is to transceive high band WWAN signals and a second antenna coupled to a Global Positioning System (GPS) signal processor and a first Wireless Local Area Network (WLAN) signal processor, where the second antenna is to transceive GPS signals and WLAN signals.

### BACKGROUND

Electronic devices, such as laptops, cellular phones, and tablets include antennas for wireless communication. Such antennas may be mounted in an enclosure or housing of the electronic device. The antennas enable communication between electronic devices and wireless networks and satellite navigation systems.

### BRIEF DESCRIPTION OF DRAWINGS

The following detailed description references the drawings, wherein:

FIG. 1 illustrates a schematic representation of an enclosure of an electronic device, according to an example implementation of the present subject matter;

FIG. 2 illustrates a schematic representation of an enclosure of an electronic device, according to another example implementation of the present subject matter;

FIG. 3 illustrates an electronic device, according to an example implementation of the present subject matter; and

FIG. 4 illustrates another electronic device, according to an example implementation of the present subject matter.

### DETAILED DESCRIPTION

Electronic devices have an enclosure or housing in which electronic components, such as a processor, a memory, a power source, a cooling fan, an I/O port, an antenna, etc., are present. The enclosure of an electronic device also houses a radio transceiver circuitry which may include multiple signal processors for processing various communication signals over different radio frequency channels. One or more signal processors may be coupled to an in-built antenna for transceiving the signals. The signal processors can generate communication signals for transmission and can also process and decode received communication signals. The signal processors may be main signal processors which are capable of both generating signals for transmission and decoding received signals; or auxiliary signal processors which are capable of decoding received signals.

In the radio transceiver circuitry, generally, an Input/Output (I/O) port of a low band Wireless Wide Area Network (WWAN) main signal processor, an I/O port of a mid band WWAN main signal processor, and an I/O port of a high band WWAN main signal processor are multiplexed together to a single port to which a first antenna is connected. This multiplexing is usually done by using two diplexers. The first antenna transceives WWAN signals over the low-band, mid-band, and high-band. Further, an I/O port of a WWAN auxiliary signal processor and an I/O port of a Global Positioning System (GPS) signal processor are multiplexed together to a single port to which a second antenna is connected. The I/O port of the WWAN auxiliary signal processor and the I/O port of the GPS signal processor is multiplexed using another diplexer. The second antenna receives WWAN signals and GPS signals.

The diplexers in the radio transceiver circuitry increases insertion loss and thereby reduces signal strength and affects signal quality. Also, the electronic devices having the radio transceiver circuitry are generally compact in nature. The diplexers in the radio transceiver circuitry may utilize more space thereby adversely affecting the compactness of the electronic devices.

The present subject matter relates to configuration and arrangement of antennas in an electronic device. According to the present subject matter, a separate antenna is coupled to a high band Wireless Wide Area Network (WWAN) main signal processor; and a single antenna is coupled to a Global Positioning System (GPS) signal processor and a Wireless Local Area Network (WLAN) signal processor.

In an example implementation, a first antenna is coupled to the high band WWAN main signal processor. The first antenna is to transceive high band WWAN signals. A second antenna is coupled to the GPS signal processor and a WLAN signal processor. The second antenna is to transceive GPS signals and WLAN signals

Thus, with the proposed subject matter, high band WWAN signals are transceived through a separate antenna, which is not otherwise the case in a RF transceiver circuitry. Hence, the I/O port of the high band WWAN main signal processor is not multiplexed with the I/O ports of the mid-band and low-band WWAN main signal processors, thereby reducing the number of diplexers in the radio transceiver circuitry by one. Due to elimination of the diplexer from the radio transceiver circuitry, insertion loss may be reduced, thereby improving signal strength.

Further, in the proposed subject matter, a single antenna is coupled to the GPS signal processor and the WLAN signal processor. To this end, the I/O port of the GPS signal processor is multiplexed with the I/O port of the WLAN signal processor, instead of being multiplexed with the I/O port of the WWAN auxiliary signal processor as in other systems. The insertion loss at a diplexer multiplexing the I/O port of the GPS signal processor with the I/O port of the WLAN signal processor is less as compared to the insertion loss at the diplexer multiplexing the I/O port of the GPS signal processor with the I/O port of the WWAN auxiliary signal processor. This is because, when GPS signals and WWAN signals pass through a diplexer, greater power is consumed by the diplexer to multiplex/demultiplex the GPS and WWAN signals, since the difference in operating frequencies of the GPS and WWAN signals is small, i.e., in the order of 100-200 Mega Hertz (MHz). Whereas, when GPS signals and WLAN signals pass through a diplexer, lesser power is consumed by the diplexer to multiplex/demultiplex the GPS and WLAN signals as the difference in operating frequencies of the GPS and WLAN signals is comparatively larger, i.e., in the order of 900 MHz to 1 Giga Hertz (GHz). Hence, with the antenna configuration of the present subject matter insertion loss is further reduced which provides improved signal strength and better signal quality.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

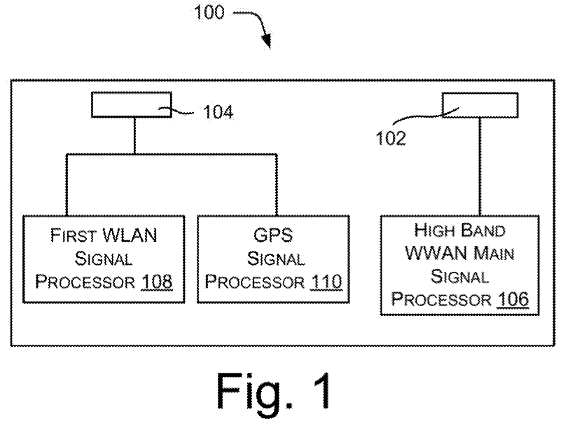

FIG. 1 illustrates an enclosure 100 of an electronic device, according to an example implementation of the present subject matter. In an example implementation, the enclosure 100 may be formed of metal, plastic, metal-plastic composite, and a combination thereof. The enclosure 100 may be formed by a molding process and may include slots (not shown) for mounting of different electronic components which are housed within the enclosure 100.

In an example implementation, the enclosure 100 includes a first antenna 102 and a second antenna 104, housed within the enclosure 100. In an example implementation, the first and second antennas 102 and 104 may be a slot antenna, a loop antenna, a planar inverted-F antenna, a cavity antenna, and a hybrid slot antenna.

The enclosure 100 further includes a high band Wireless Wide Area Network (WWAN) main signal processor 106, a Wireless Local Area Network (WLAN) signal processor 108, and a Global Positioning System (GPS) signal processor 110. In an example implementation, the high band WWAN main signal processor 106, the WLAN signal processor 108, and the GPS signal processor 110 may be included in a radio frequency (RF) front-end circuitry of an electronic device, such as a tablet, a laptop, a smartphone, or the like, associated with the enclosure 100. The RF front-end circuitry refers to the circuitry between an antenna and a signal processor and includes the signal processor. In an example implementation, the signal processor may include an RF filter, an RF amplifier, a mixer, an oscillator, a modulator/demodulator, a low-noise converter, etc.

The high band WWAN main signal processor 106 can generate high band WWAN signals for transmission and can decode received high band WWAN signals. In an example implementation, the high band WWAN signals operate in a frequency range of 2.3 GHz to 2.69 GHz. The WLAN signal processor 108 can generate WLAN signals for transmission and decode received WLAN signals. In an example implementation, the WLAN signals operate in a frequency band of one of 2.4 GHz and 5 GHz. The WLAN signal processor 108 is also referred to as a first WLAN signal processor 108. In an example implementation, the first WLAN signal processor 108 may be a dual band signal processor operable over both 2.4 GHz and 5 GHz frequency bands. In another example implementation, the first WLAN signal processor 108 may be operable over a single frequency band, say 2.4 GHz or 5 GHz. The GPS signal processor 110 can decode received GPS signals. In an example implementation, the GPS signals operate in a frequency of about 1.5 GHz.

In an example implementation, as shown in FIG. 1, the first antenna 102 is coupled to the high band WWAN main signal processor 106 and is operable to transceive high band WWAN signals. In an example implementation, a radiating element of the first antenna 102 may be coupled to the high band WWAN main signal processor 106 through a co-axial cable. The second antenna 104 is coupled to the GPS signal processor 110 and the first WLAN signal processor 108 and is operable to transceive GPS signals and WLAN signals. In an example implementation, a radiating element of the second antenna 104 may be coupled to the GPS signal processor 110 and the first WLAN signal processor 108 through a co-axial cable.

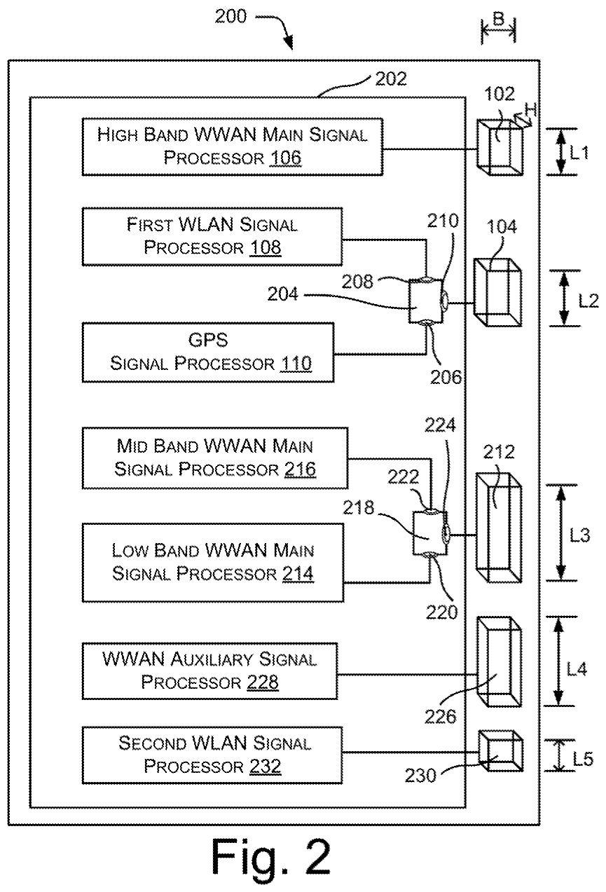

FIG. 2 illustrates an enclosure 200 of an electronic device, according to an example implementation of the present subject matter. Examples of the electronic device include a tablet, a laptop, a smartphone, or the like. The enclosure 200 includes an RF circuitry 202. In an example implementation, the RF circuitry 202 is an RF front-end circuitry and includes signal processors for processing signals over different communication channels. The enclosure 200 includes all the components housed inside the enclosure 100 along with other additional components. Thus, as can be seen from FIG. 2, the enclosure 200 includes the first antenna 102 and the second antenna 104. In an example implementation, the first antenna 102 may be a cuboidal cavity antenna and may have a length ‘L1’ of about 15 mm, a breadth ‘B’ of about 11 mm, and a height ‘H’ of about 2.5 mm. In an example implementation, the second antenna 104 may be a cuboidal cavity antenna and may have a length ‘L2’ of about 20 mm, a breadth ‘B’ of about 11 mm, and a height ‘H’ of about 2.5 mm.

The enclosure 200 further includes a first diplexer 204. The first diplexer 204 is in the RF circuitry 202. The second antenna 104 is coupled to the first WLAN signal processor 108 and the GPS signal processor 110 through the first diplexer 204. The first diplexer 204 has a first port 206, a second port 208, and a third port 210. The first, second and third ports 206, 208, and 210 are contact points for establishing an electrical connection between the first diplexer 204 and antennas, signal processors, and other electronic components. The first diplexer 204 multiplexes the first port 206 and the second port 208 onto the third port 210.

The first port 206 of the first diplexer 204 is coupled to the GPS signal processor 110, the second port 208 of the first diplexer 204 is coupled to the first WLAN signal processor 108, and the third port 210 of the first diplexer 204 is coupled to the second antenna 104. WLAN signals and GPS signals received by the second antenna 104 may be transmitted to the first diplexer 204 through the third port 210. The first diplexer 204 can segregate received WLAN signals from the GPS signals and forward the WLAN signals to the WLAN auxiliary signal processor 108 and the GPS signals to the GPS signal processor 110. Thus, the received signals are segregated and forwarded to the respective signal processors through the first diplexer 204.

The enclosure 200 further includes a third antenna 212. The third antenna 212 is coupled to a low band WWAN main signal processor 214 and a mid-band WWAN main signal processor 216. The low band WWAN main signal processor 214 can generate low band WWAN signals for transmission and can decode received low band WWAN signals. In an example implementation, the low band WWAN signals operate in a frequency range of 690 Mega Hertz (MHz) to 960 Mega Hertz (MHz). The mid band WWAN main signal processor 216 can generate mid band WWAN signals for transmission and can decode received mid band WWAN signals. In an example implementation, the mid band WWAN signals operate in a frequency range of 1.7 GHz to 2.2 GHz. In an example implementation, the third antenna 212 may be a cuboidal cavity antenna and may have a length ‘L3’ of about 80 mm, a breadth ‘B’ of about 11 mm, and a height (not shown) of about 2.5 mm.

As shown in FIG. 2, the enclosure 200 includes a second diplexer 218. The second diplexer 218 is in the RF circuitry 202. The third antenna 212 is coupled to the low band WWAN main signal processor 214 and the mid band WWAN main signal processor 216 through the second diplexer 218. The second diplexer 218 has a fourth port 220, a fifth port 222, and a sixth port 224. The fourth, fifth and sixth ports 220, 222, and 224 are contact points for establishing electrical connections between the second diplexer 218 and antennas, signal processors, and other electronic components. The second diplexer 218 multiplexes the fourth port 220 and the fifth port 222 onto the sixth port 224.

The fourth port 220 of the second diplexer 218 is coupled to the low band WWAN main signal processor 214, the fifth port 222 of the second diplexer 218 is coupled to the mid band WWAN main signal processor 216, and the sixth port 224 of the second diplexer 218 is coupled to the third antenna 212. The second diplexer 218 can combine and segregate low band WWAN signals from the mid band WWAN signals. Thus, the second diplexer 218 enables signals generated by the low band WWAN main signal processor 214 and signals generated by the mid band WWAN main signal processor 216 to be multiplexed and forwarded to the third antenna 212 for transmission. Similarly, signals received by the third antenna 212 are segregated and forwarded to the respective signal processors.

The enclosure 200 further includes a fourth antenna 226. The fourth antenna 226 is coupled to a WWAN auxiliary signal processor 228 and is operable to receive WWAN signals. The WWAN auxiliary signal processor 228 is included in the RF circuitry 202 and can decode WWAN signals received at the fourth antenna 226. In an example implementation, the WWAN signals received at the fourth antenna 226 are in a frequency range of 690 MHz to 2.69 GHz. In an example implementation, the mid band WWAN signals operate in a frequency range of 1.7 GHz to 2.2 GHz. In an example implementation, the fourth antenna 226 may be a cuboidal cavity antenna and may have a length ‘L4’ of about 50 mm, a breadth ‘B’ of about 11 mm, and a height (not shown) of about 2.5 mm.

The enclosure 200 further includes a fifth antenna 230. The fifth antenna 230 is coupled to a second WLAN signal processor 232 and is operable to transceive WLAN signals. The second WLAN signal processor 232 is in the RF circuitry 202. The second WLAN signal processor 232 can generate WLAN signals for being transmitted through the fifth antenna 230 and can decode WLAN signals received at the fifth antenna 230. In an example implementation, the WLAN signals received at the fifth antenna 230 may operate in a frequency band of one of 2.4 GHz and 5 GHz. In an example implementation, the fifth antenna 230 may be a cuboidal cavity antenna and may have a length ‘L5’ of about 50 mm, a breadth ‘B’ of about 11 mm, and a height (not shown) of about 2.5 mm.

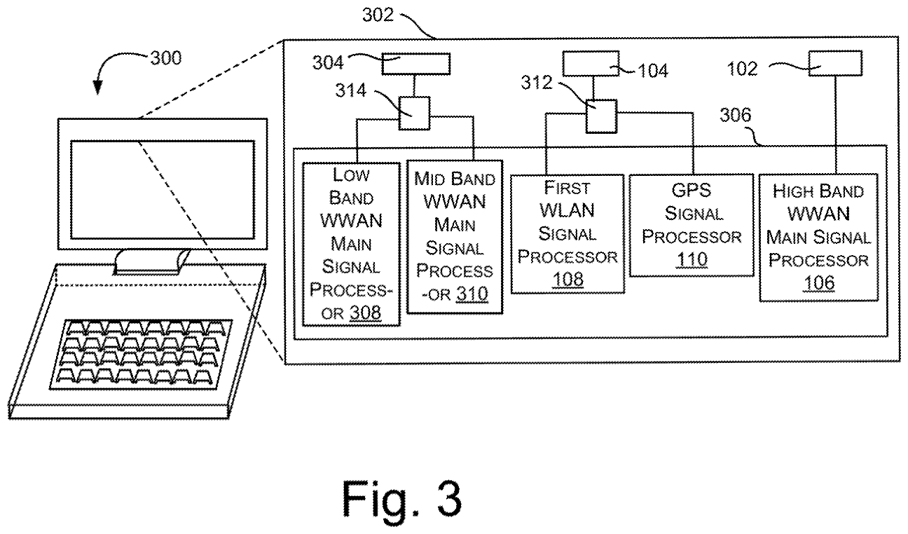

FIG. 3 illustrates a schematic representation of an electronic device 300, according to an example implementation of the present subject matter. Examples of the electronic device 300 include a laptop, a notebook, etc. The electronic device 300 has an enclosure 302. The enclosure 302 includes components similar to the components housed within the enclosure 100 or the enclosure 200, as illustrated through FIGS. 1 and 2. Thus, as shown in FIG. 3, the electronic device 300 includes the first antenna 102, the second antenna 104, the high band WWAN main signal processor 104, the WLAN auxiliary signal processor 108, and the GPS signal processor 110.

The electronic device 300 includes a third antenna 304. In an example implementation, the third antenna 304 is operable to transceive low band Wireless Wide Area Network (WWAN) signals and mid-band WWAN signals. In an example implementation, the third antenna 304 is identical to the third antenna 212 of FIG. 2 and performs identical functions as that of the third antenna 212. In an example implementation, the electronic device 300 may also include a fourth antenna (not shown) identical to the fourth antenna 226 of FIG. 2 and a fifth antenna 230 identical to the fifth antenna 230 of FIG. 2.

The electronic device 300 includes an RF front end circuitry 306 housed in the enclosure 302. In an example implementation, the RF front end circuitry 306 may be housed within a casing of a display panel of the electronic device 300. The high band WWAN main signal processor 104, the first WLAN signal processor 108, and the GPS signal processor 110 are included within the RF front end circuitry 306. The RF front end circuitry 306 further includes a low band WWAN main signal processor 308 and a mid-band WWAN main signal processor 310. In an example implementation, the low band WWAN main signal processor 308 is identical to the low band WWAN main signal processor 214 of FIG. 2, and the mid band WWAN main signal processor 310 is identical to the mid band WWAN main signal processor 216 of FIG. 2.

The RF front end circuitry 306 further includes a first diplexer 312. The first diplexer 312 couples the first WLAN signal processor 108 and the GPS signal processor 110 to the second antenna 104. In an example implementation, the first diplexer 312 is identical to the first diplexer 204 of FIG. 2 and performs identical functions as that of the first diplexer 204.

The RF front end circuitry 306 further includes a second diplexer 314. The second diplexer 314 couples the low band WWAN main signal processor 308 and the mid-band WWAN main signal processor 310 to the third antenna 304. In an example implementation, the second diplexer 314 is identical to the second diplexer 218 of FIG. 2 and performs identical functions as that of the second diplexer 218.

In an example implementation, the RF front end circuitry 306 may further include a WWAN auxiliary signal processor (not shown in FIG. 3) similar to the WWAN auxiliary signal processor 228 of FIG. 2 and a WLAN main signal processor similar to the WLAN main signal processor 232 of FIG. 2. The WWAN auxiliary signal processor may be coupled to the fourth antenna and the WLAN main signal processor may be coupled to the fifth antenna.

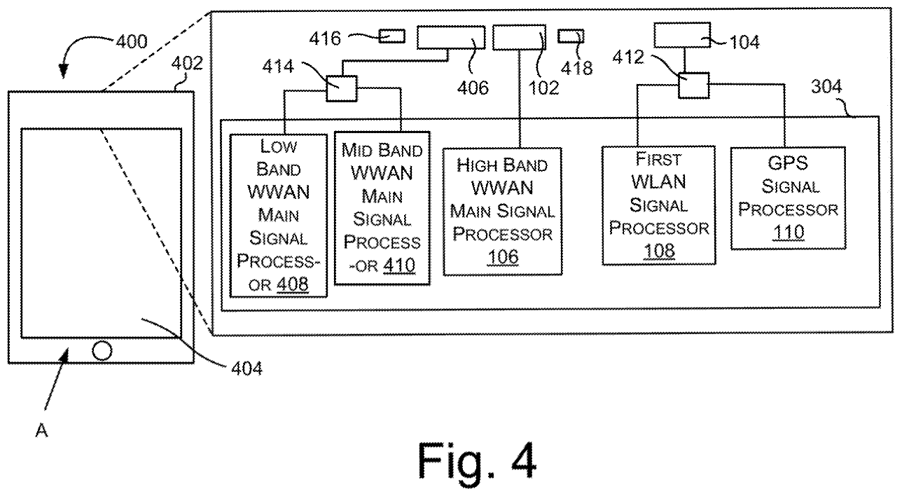

FIG. 4 illustrates a schematic representation of an electronic device 400, according to an example implementation of the present subject matter. Examples of the electronic device 400 include handheld devices, such as tablets, smartphones, etc. The electronic device 400 has an enclosure 402. The enclosure 402 may house electronic components of the electronic device 400. The electronic device 400 further includes a display panel 404 mounted on a front side of the enclosure 402. The front side is depicted by arrow A. The display unit 404 may render visual content at the front side. In an example implementation, the display unit 404 may be a touch-sensitive display and may receive touch-based user inputs.

An exploded view of the enclosure 402 is shown in FIG. 4. In an example implementation, the enclosure 402 includes components similar to the components housed within the enclosures 100, 200, and 302 as illustrated through FIGS. 1, 2, and 3. Thus, as shown in FIG. 4, the enclosure 402 includes the first antenna 102 positioned on the front side, the second antenna 104 positioned on the front side, the high band WWAN main signal processor 104, the first WLAN signal processor 108, and the GPS signal processor 110.

The enclosure 402 includes a third antenna 406. In an example implementation, the third antenna 406 is operable to transceive low band Wireless Wide Area Network (WWAN) signals and mid-band WWAN signals. In an example implementation, the third antenna 406 is identical to the third antenna 212 of FIG. 2 and performs identical functions as that of the third antenna 212. In an example implementation, the enclosure 402 of the electronic device 400 may also include a fourth antenna (not shown) identical to the fourth antenna 226 of FIG. 2 and a fifth antenna (not shown) identical to the fifth antenna 230 of FIG. 2.

As shown in FIG. 4, the enclosure 402 further includes a low band WWAN main signal processor 408 and a mid-band WWAN main signal processor 410. In an example implementation, the low band WWAN main signal processor 408 is identical to the low band WWAN main signal processor 214 of FIG. 2, and the mid band WWAN main signal processor 410 is identical to the mid band WWAN main signal processor 216 of FIG. 2.

The enclosure 402 further includes a first diplexer 412. The first WLAN signal processor 108 and the GPS signal processor 110 is coupled to the second antenna 104 through the first diplexer 412. In an example implementation, the first diplexer 412 is identical to the first diplexer 204 of FIG. 2 and performs identical functions as that of the first diplexer 204.

The enclosure 402 further includes a second diplexer 414. The low band WWAN main signal processor 408 and the mid-band WWAN main signal processor 410 is coupled to the third antenna 406 through the second diplexer 414. In an example implementation, the second diplexer 414 is identical to the second diplexer 218 of FIG. 2 and performs identical functions as that of the second diplexer 218.

In an example implementation, the enclosure 402 may further include a WWAN auxiliary signal processor (not shown in FIG. 4) similar to the WWAN auxiliary signal processor 228 of FIG. 2 and a second WLAN signal processor (not shown in FIG. 4) similar to the second WLAN signal processor 232 of FIG. 2. The WWAN auxiliary signal processor may be coupled to the fourth antenna and the second WLAN signal processor may be coupled to the fifth antenna.

The enclosure 402 further includes two proximity sensors, 416 and 418. The proximity sensor 416 is referred to as a first proximity sensor 416 and the proximity sensor 418 is referred to as a second proximity sensor 418. The proximity sensors, 416 and 418 are arranged on the front side of the electronic device 400. As can be seen from FIG. 4, the first antenna 102 and the third antenna 406 are spanning between the two proximity sensors 416 and 418. The proximity sensors, 416 and 418 detect a distance of a user's bodypart from the first and second antennas 102 and 406 and depending on the detected distance, the proximity sensors generate control signals for regulating a transmission signal strength of the first and third antennas 102 and 406. This helps in controlling Specific Absorption Rate (SAR) of a user using the electronic device 400. In an example implementation, the enclosure 402 may include a RF front end circuitry, such as the RF front end circuitry 306 of FIG. 3.

Although implementations of enclosures of electronic devices and electronic devices having such enclosures are described in language specific to methods and/or structural features, it is to be understood that the present subject matter is not limited to the specific methods or features described. Rather, the methods and specific features are disclosed and explained as example implementations of enclosures of electronic devices and electronic devices having such enclosures.

We claim:

1. An enclosure for an electronic device, comprising:
a first antenna coupled to a high band Wireless Wide Area Network (WWAN) main signal processor, wherein the first antenna is to transceive high band WWAN signals; and
a second antenna coupled to a Global Positioning System (GPS) signal processor and a first Wireless Local Area Network (WLAN) signal processor, wherein the second antenna is to transceive GPS signals and WLAN signals.

2. The enclosure as claimed in claim 1, further comprising a first diplexer having:
a first port;
a second port; and
a third port, wherein the first diplexer multiplexes the first and second ports onto the third port, the first port being coupled to the GPS signal processor, the second port being coupled to the first WLAN signal processor, and the third port being coupled to the second antenna.

3. The enclosure as claimed in claim 1, further comprising a third antenna coupled to a low band WWAN main signal processor and a mid-band WWAN main signal processor, wherein the third antenna is to transceive low band WWAN signals and mid-band WWAN signals.

4. The enclosure as claimed in claim 3, further comprising a second diplexer having:
a fourth port;
a fifth port; and
a sixth port, wherein the second diplexer multiplexes the fourth and the fifth ports onto the sixth port, the fourth port being coupled to the low band WWAN main signal processor, the fifth port being coupled to the mid-band WWAN main signal processor, and the sixth port being coupled to the third antenna.

5. The enclosure as claimed in claim 1, further comprising a fourth antenna coupled to a WWAN auxiliary signal processor, wherein the fourth antenna is to receive WWAN signals.

6. The enclosure as claimed in claim 1, further comprising a fifth antenna coupled to a second WLAN signal processor, wherein the fifth antenna is to transceive WLAN signals.

7. An electronic device comprising:
a first antenna to transceive high band WWAN signals;
a second antenna to transceive Global Positioning System (GPS) signals and Wireless Local Area Network (WLAN) signals; and
a third antenna to transceive low band Wireless Wide Area Network (WWAN) signals and mid-band WWAN signals;
a Radio Frequency (RF) front-end circuitry comprising:
a high band WWAN main signal processor coupled to the first antenna;
a GPS signal processor;
a first WLAN signal processor;
a first diplexer to couple the GPS signal processor and the first WLAN signal processor to the second antenna;
a low band WWAN main signal processor;
a mid-band WWAN main signal processor; and
a second diplexer to couple the mid-band WWAN main signal processor and the low band WWAN main signal processor to the third antenna;

8. The electronic device as claimed in claim 7, wherein the first diplexer comprises:
a first port;
a second port; and
a third port, wherein the first diplexer multiplexes the first and second ports onto the third port, the first port being coupled to the GPS signal processor, the second port being coupled to the first WLAN signal processor, and the third port being coupled to the third antenna.

9. The electronic device as claimed in claim 7, wherein the second diplexer comprises:
a fourth port;
a fifth port; and
a sixth port, wherein the first diplexer multiplexes the fourth and fifth ports onto the sixth port, the fourth port being coupled to the low band WWAN main signal processor, the fifth port being coupled to the mid-band WWAN main signal processor, and the sixth port being coupled to the third antenna.

10. The electronic device as claimed in claim 7, further comprising a fourth antenna to receive WWAN signals, wherein the RF front-end circuitry comprises a WWAN auxiliary signal processor coupled to the fourth antenna.

11. The electronic device as claimed in claim 7, further comprising a fifth antenna to transceive WLAN signals, wherein the RF front-end circuitry comprises a second WLAN signal processor coupled to the fifth antenna.

12. An electronic device comprising:
an enclosure; and
a display panel mounted on a front side of the enclosure, wherein the enclosure comprises:
two proximity sensors arranged on the front side;
a first antenna positioned on the front side, the first antenna being coupled to a high band WWAN main signal processor, wherein the first antenna is to transceive high band WWAN signals;
a second antenna positioned on the front side, the second antenna being coupled to a Global Positioning System (GPS) signal processor and a first WLAN signal processor through a first diplexer, wherein the second antenna is to transceive GPS signals and WLAN signals; and
a third antenna positioned on the front side abutting one of the two proximity sensors, the first antenna and the third antenna spanning between the two proximity sensors, the third antenna being coupled to a low band Wireless Wide Area Network (WWAN) main signal processor and a mid-band WWAN main signal processor through a second diplexer, wherein the third antenna is to transceive low band WWAN signals and mid-band WWAN signals;

13. The electronic device as claimed in claim 12, wherein the first diplexer comprises:
a first port;
a second port; and
a third port, wherein the first diplexer multiplexes the first and second ports onto the third port, the first port being coupled to the GPS signal processor, the second port being coupled to the first WLAN signal processor, and the third port being coupled to the second antenna.

14. The electronic device as claimed in claim 12, wherein the second diplexer comprises:
a fourth port;
a fifth port; and
a sixth port, wherein the second diplexer multiplexes the fourth and fifth ports onto the sixth port, the fourth port being coupled to the low band WWAN main signal processor, the fifth port being coupled to the mid-band WWAN main signal processor, and the sixth port being coupled to the third antenna.

15. The electronic device as claimed in claim 12, wherein the enclosure further comprises a fourth antenna coupled to a WWAN auxiliary signal processor, wherein the fourth antenna is to receive WWAN signals.
